(19) United States
(12) Patent Application Publication
(10) Pub. No.: US 2009/0224492 A1
(43) Pub. Date: Sep. 10, 2009

(54) Bit connector with quick release device

(76) Inventor: Jack Lin, Taichung (TW)

Correspondence Address: Jack Lin, P. O. Box 215, Taichung, 40099, TW

(21) Appl. No.: 12/073,726

(22) Filed: Mar. 10, 2008

(51) Int. Cl. B23B 31/107

(52) U.S. Cl. 279/82; 279/143

(57) ABSTRACT

A bit connector includes a tubular member having a polygonal hole for receiving a screw bit. A first hole and a second hole are defined radially through a wall of the tubular member, wherein the second hole communicates with the polygonal hole. A pin movably extends through two slots defined through the wall of the tubular member. A first bead and a second bead are received in the first and second holes respectively. A sleeve is mounted to the tubular member and includes a tapered inner wall so as to press the second bead to contact against the screw bit. An end piece is mounted to the tubular member and engaged with an end of the sleeve. A spring is biased between the end piece and the pin. The end piece includes two recesses and the-first bead is engaged with one of the two recesses.

### FIELD OF THE INVENTION

The present invention relates to a bit connector with a quick release device which includes a sleeve movably mounted to the connector so as to change the positions of two beads to secure or release the bit.

### BACKGROUND OF THE INVENTION

A conventional bit connector generally includes a tubular member with a polygonal hole in an end and a bit can be inserted into the polygonal hole. A radial hole is defined through the tubular member and a bead is engaged with the radial hole so as to contact against the bit. A sleeve is mounted to the tubular member and cooperated with a spring which is in contact with the tubular member. The sleeve includes a curved inner wall to press the bead. A circular hole is defined in the tubular member so as to receive a positioning member and a spring, the positioning member includes a notch which is located corresponding to the radial hole. By moving the sleeve, the bead is pressed or released by the curved inner wall of the sleeve. The bead is engaged with the notch so that the sleeve and the positioning member are positioned. It is difficult to install the bead and the positioning member in the radial hole and the circular hole during the assembly of the product.

The present invention intends to provide a quick release device for a bit connector and the device is easily to be assembled.

The quick release device can securely position the bit or quick release the bit from the connector.

### SUMMARY OF THE INVENTION

The present invention relates to a bit connector which comprises a tubular member having a polygonal hole defined in a first end thereof so as to receive a screw bit therein and a polygonal section extends from a second end of the tubular member so as to be connected with a power tool. A first hole is defined radially through a wall of the tubular member and a second hole is defined radially through the wall of the tubular member. The second hole communicates with the polygonal hole. Two slots are defined through the wall of the tubular member and communicate with the polygonal hole. A first bead and a first spring are received in the first hole and the first bead is biased by the first spring outward. A second bead is received in the second hole. A movable member is received in the polygonal hole and a pin extends through the slots and the movable member. A sleeve is mounted to the first end of the tubular member and includes a tapered inner wall so as to press the second bead. A flange extends inward from a first open end of the sleeve and an end piece is mounted to the tubular member and engaged with a second open end of the sleeve. A second spring is mounted to the tubular member and biased between the end piece and the pin. The end piece includes a first recess and second recess defined in an inner wall thereof. The first bead is engaged with one of the first and second recesses.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bit connector of the present invention;

FIG. 2 is a perspective view to show the bit connector of the present invention;

FIG. 3 is a cross sectional view to show the sleeve is located at the first position;

FIG. 4 is a cross sectional view from another angle to show the sleeve is located at the first position;

FIG. 5 is a cross sectional view to show the sleeve is located at the second position wherein the screw bit is secured positioned by the second bead, and

FIG. 6 is a cross sectional view from another angle to show that the sleeve is located at the second position.

### DETAILED DESCRIPTION OF THE PREFERRED EMBODIMENT

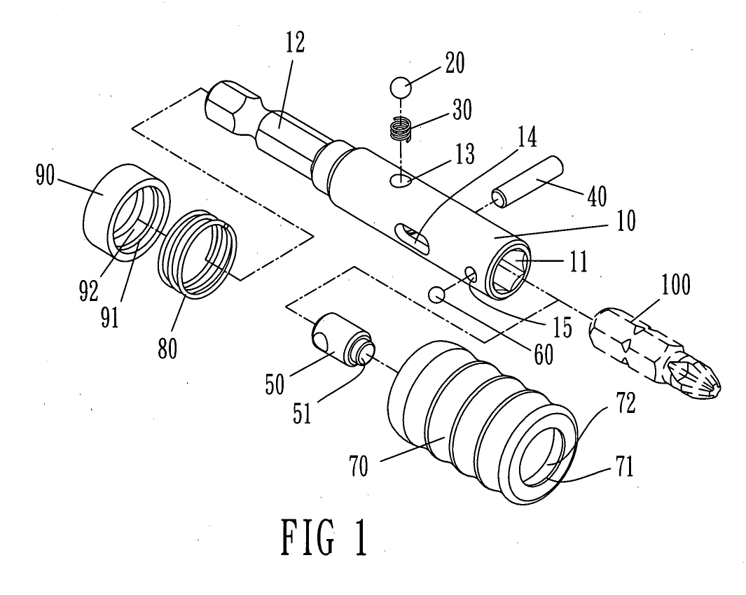

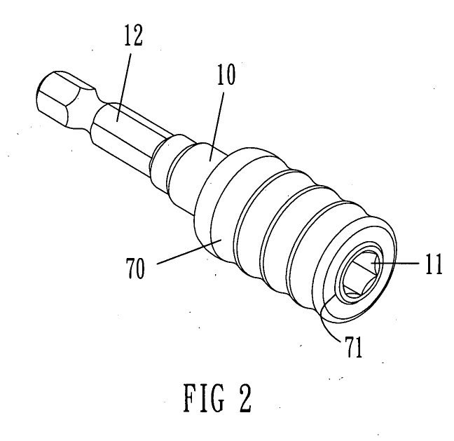

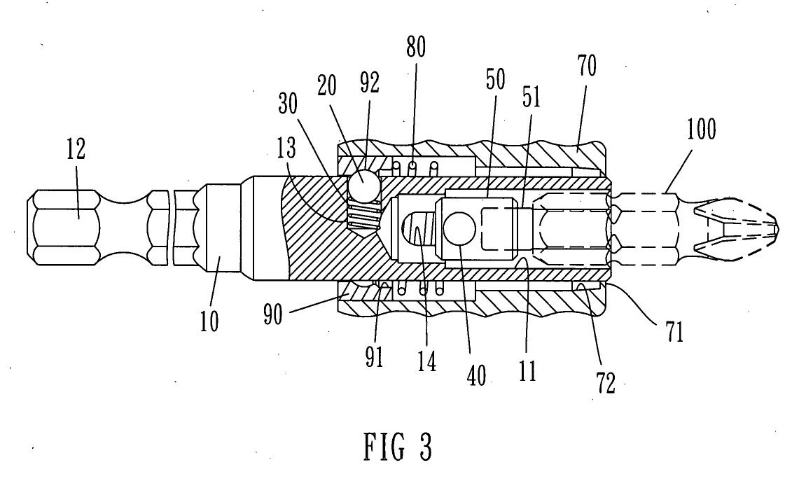

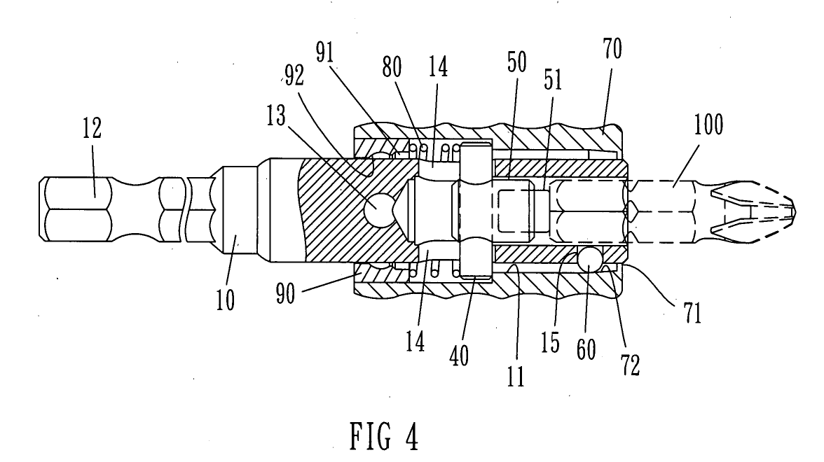

Referring to FIGS. 1 to 4, the bit connector of the present invention comprises a tubular member 10 having a polygonal hole 11 defined in a first end thereof so as to receive a screw bit 100 therein and a polygonal section 12 extends from a second end of the tubular member 10 such that a power tool (not shown) can be connected with the polygonal section 12. A first hole 13 is defined radially through a wall of the tubular member 10 and located close to the second end of the tubular member 10. A second hole 15 is defined radially through the wall of the tubular member 10 and located close to the first end of the tubular member 10. The second hole 15 communicates with the polygonal hole 11. Two elongate slots 14 are defined through the wall of the tubular member 10 and communicate with the polygonal hole 11.

A first bead 20 and a first spring 30 are received in the first hole 13 and the first bead 20 is biased by the first spring 30 outward. The second hole 15 has a cone-shaped inner periphery and a second bead 60 is movably received in the second hole 15. A movable member 50 is received in the polygonal hole 11 and includes a permanent magnet 51 on an end thereof so as to magnetically attract the bit screw 100. A pin 14 extends through the slots 14 and the movable member 50, and two ends of the pin 14 extend out from the slots 14.

A sleeve 70 is mounted to the first end of the tubular member 10 and includes a tapered inner wall 72 so as to removably press the second bead 60. A flange 71 extends inward from a first open end of the sleeve 70 and an end piece 90 is mounted to the tubular member 10 and engaged with a second open end of the sleeve 70. A second spring 80 is mounted to the tubular member 10 and biased between the end piece 90 and the pin 40. The end piece 90 includes a first recess 91 and second recess 92 defined in an inner wall thereof, the first bead 20 is engaged with one of the first and second recesses 91, 92.

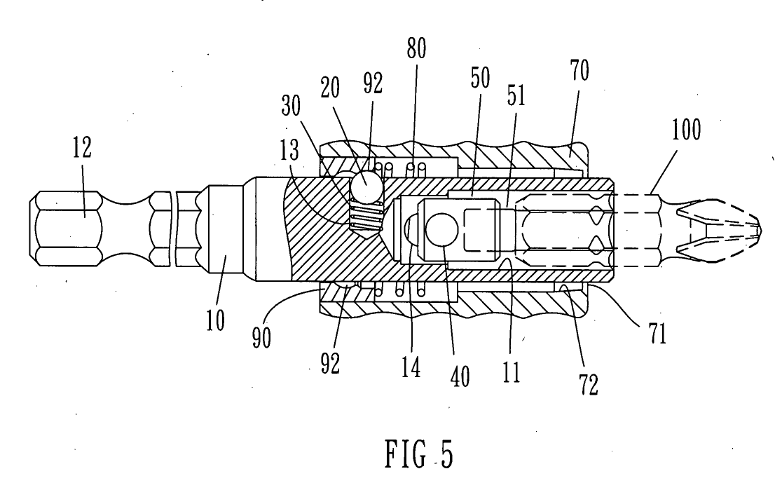

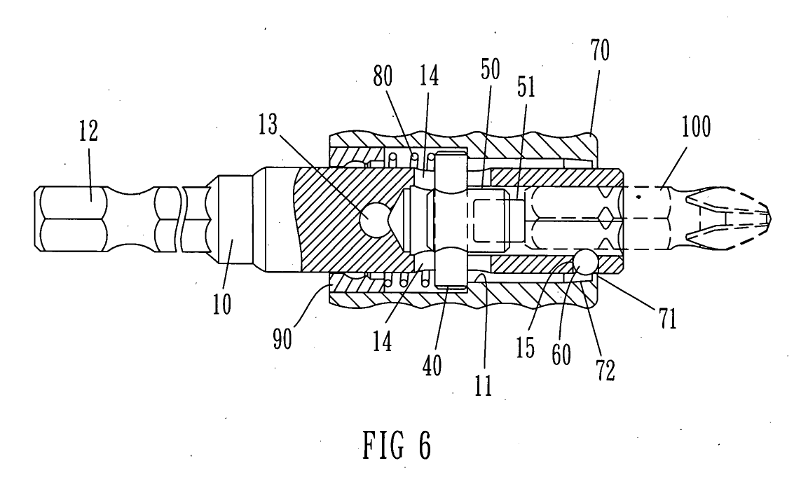

As shown in FIGS. 5 and 6, when pulling the sleeve 70 to its first position, the tapered inner wall 72 presses the second bead 60 to contact the screw bit 100, and the two ends of the pin 14 are pushed by a shoulder portion in the sleeve 70 so that the second spring 80 is compressed and the end piece 90 is moved with the movement of the sleeve 70. The first bead 20 is then removed from the first recess 91 and engaged with the second recess 92. The engagement of the first bead 20 and the second recess 92 positions the end piece 90 and the sleeve 70. The flange 71 of the sleeve 70 is moved to stop the second bead 60 from moving outward. Therefore, the screw bit 100 is positioned.

When releasing the screw bit 100, the sleeve 70 is pulled toward the first end of the tubular member 10, the flange 71 is removed from the second bead 60 and the tapered inner wall 72 of the sleeve 70 allows the second bead 60 to move outward. The second spring 80 then pushes the pin 40 to move the movable member 50 to project the screw bit 100. The first bead 20 is removed from the second recess 92 and engaged with the first recess 91.

While we have shown and described the embodiment in accordance with the present invention, it should be clear to those skilled in the art that further embodiments may be made without departing from the scope of the present invention.

What is claimed is:

1. A bit connector comprising:
a tubular member having a polygonal hole defined in a first end thereof and a polygonal section extending from a second end of the tubular member, a first hole defined radially through a wall of the tubular member and located close to the second end of the tubular member, a second hole defined radially through the wall of the tubular member and located close to the first end of the tubular member, the second hole communicating with the polygonal hole, two slots defined through the wall of the tubular member and communicating with the polygonal hole;
a first bead and a first spring received in the first hole and the first bead being biased by the first spring outward, a second bead received in the second hole, a movable member received in the polygonal hole and a pin extending through the slots and the movable member, and
a sleeve mounted to the first end of the tubular member and including a tapered inner wall so as to press the second bead, a flange extending inward from a first open end of the sleeve and an end piece mounted to the tubular member and engaged with a second open end of the sleeve, a second spring mounted to the tubular member and biased between the end piece and the pin, the end piece including a first recess and second recess defined in an inner wall thereof, the first bead being engaged with one of the first and second recesses.

2. The bit connector as claimed in claim 1, wherein the second hole includes a cone-shaped inner periphery and the second bead is movably received in the second hole.

3. The bit connector as claimed in claim 1, wherein a permanent magnet is connected to the movable member and faces the polygonal hole.
